(19) United States
(12) Patent Application Publication
(10) Pub. No.: US 2018/0101018 A1
(43) Pub. Date: Apr. 12, 2018

(54) LIGHT-FIELD DISPLAY

(71) Applicant: SAMSUNG ELECTRONICS CO., LTD., Suwon-si (KR)

(72) Inventors: Jaeseung CHUNG, Suwon-si (KR); Joonyong PARK, Suwon-si (KR); Dongouk KIM, Pyeongtaek-si (KR); Jihyun BAE, Seoul (KR); Dongsik SHIM, Hwaseong-si (KR); Sunghoon LEE, Seoul (KR); Bongsu SHIN, Seoul (KR); Seokho SONG, Seoul (KR)

(73) Assignee: SAMSUNG ELECTRONICS CO., LTD., Suwon-si (KR)

(21) Appl. No.: 15/720,887

(22) Filed: Sep. 29, 2017

(30) Foreign Application Priority Data
Oct. 11, 2016 (KR) 10-2016-0131617

(51) Int. Cl. G02B 27/22; H04N 13/04

(52) U.S. Cl. CPC G02B 27/2214; H04N 13/0497; H04N 13/0459

(57) ABSTRACT

A light-field display device includes a screen, a grating pixel array, and an image generator. The image generator outputs light including three-dimensional (3D) image information. The grating pixel array is configured to diffract the light including the 3D image information in multiple directions, thereby forming a 3D image. The image generator outputs the light having the 3D image information to the screen at a predetermined angle.

### CROSS-REFERENCE TO RELATED APPLICATION

This application claims the priority from Korean Patent Application No. 10-2016-0131617, filed on Oct. 11, 2016, in the Korean Intellectual Property Office, the disclosure of which is incorporated herein in its entirety by reference.

### BACKGROUND

### 1. Field

The present disclosure relates to a light-field display device.

### 2. Description of the Related Art

Related art three-dimensional (3D) image display devices display 3D images based on binocular parallax. Current, commercialized 3D image display devices use binocular parallax and provide a left-eye image and a right-eye image having different viewpoints to a left eye and a right eye, respectively, of a viewer, so that the viewer may observe a stereoscopic effect. Such 3D image devices are classified as eyeglass-type displays that require special eyeglasses or as glassesless displays that do not require the use of special eyeglasses.

Eyeglass-type display devices display different images to the two eyes of a user when the user wears the special eyeglasses, such as polarization eyeglasses or shutter-type eyeglasses. However, users may find such eyeglasses-type display devices to be bothersome, and thus use thereof may be avoided. Thus, research into glassesless 3D image display devices has been recently conducted in order to address these problems.

Examples of glassesless 3D image displays include 3D image display devices using an optical sheet (such as, lenticular Lenses or barriers), multi-projection display devices or multi-layer related display devices, and light-field display devices using a diffusing light source.

### SUMMARY

One or more exemplary embodiments may provide a light-field display device capable of realizing a 3D image according to a light-field method.

Additional exemplary aspects will be set forth in part in the description which follows and, in part, will be apparent from the description, or may be learned by practice of the presented exemplary embodiments.

According to an aspect of an exemplary embodiment, a light-field display device includes a screen and an image generator configured to radiate light having 3D image information onto the screen at a predetermined angle. The screen includes a grating pixel array configured to diffract, in multiple directions, the light having the 3D image information, so that the light diffracted by the grating pixel array of the screen forms a 3D image.

The grating pixel array may be formed on a surface of the screen or within the screen.

The image generator may be spaced apart from the screen.

The image generator may include a beam projector configured to project the light having the 3D image information onto the screen.

The image generator may include a light source; a light modulator configured to modulate the light, output by the light source, on a pixel-by-pixel basis; and a controller configured to control the light modulator to generate a pattern having the 3D image information.

The image generator may further include a beam adjustor configured to adjust a magnification of the light having the 3D image information.

The screen may include an alignment mark, and the image generator may further include a detection sensor configured to sense the alignment mark of the screen.

The image generator may be configured to generate, via one of a one-shot method, a single-spot beam scanning method, a line-beam scanning method, and a time sequential emission method, the 3D image.

The screen may be transparent.

The screen may include an alignment mark, and the image generator may be configured to sense the alignment mark of the screen and to adjust the 3D information based on the sensing of the alignment mark.

The screen may include an eyeglass lens, and the light-field display device may be used as an eyeglass-type light-field display device.

The screen may include a windshield of a car, and the light-field display device may be used as a light-field display device for an automobile.

The screen may be disposed provided on an automobile, such that the 3D image is formed on a windshield of the automobile, and the light-field display device may be used as a light-field display device for an automobile.

The screen may include a cover of a wrist-type mobile device that is opened, and the light-field display device may be used as a light-field display device for a wrist-type mobile device.

The screen may be slidably moveable with respect to a smartphone and the light-field display device may be used as a light-field display device for a smartphone.

The grating pixel array may include a 2D array of grating pixels, and each grating pixel may include a grating pattern configured to diffract light having a specific wavelength.

Each grating pixel may include a plurality of sub grating pixels, and the plurality of sub grating pixels may include sub grating patterns configured to react to light having different wavelengths.

The grating pixel array may be transparent.

### BRIEF DESCRIPTION OF THE DRAWINGS

These and/or other exemplary aspects and advantages will become apparent and more readily appreciated from the following description of the exemplary embodiment, taken in conjunction with the accompanying drawings in which:

FIG. 1 is a schematic view of a light-field display device according to an exemplary embodiment;

FIG. 2 is a block diagram of an exemplary embodiment of an image generator included in the light-field display device of FIG. 1;

FIG. 3 schematically illustrates an example of a grating pixel array that is applied to a screen of the light-field display device of FIG. 1;

FIG. 4 illustrates a magnification of a grating pixel of the grating pixel array of FIG. 3;

FIG. 5 illustrates an example in which a 3D image formed via a diffraction by a grating pixel array is formed in front side of a screen;

FIG. 6 illustrates an example in which a 3D image is formed via diffraction by a grating pixel array both in front of and behind a screen;

FIG. 7A illustrates a case wherein a light-field display device according to an exemplary embodiment replaces a screen with a general screen not including the grating pixel array and forms a 2D image;

FIG. 7B illustrates a case wherein a light-field display device according to an exemplary embodiment includes a screen including a grating pixel array and forms a 3D image;

FIG. 8 is a schematic view of a light-field display device according to another exemplary embodiment;

FIG. 9 is a schematic view of a light-field display device according to another exemplary embodiment;

FIG. 10 is a block diagram of an exemplary embodiment of an image generator included in the light-field display device of FIG. 9;

FIGS. 11 and 12 illustrate examples in which a light-field display device according to an exemplary embodiment is applied to a 3D light-field display device of an automobile;

FIG. 13 illustrates an example in which the light-field display device according to an exemplary embodiment is applied as a 3D light-field display device for a pair of 3D eyeglasses;

FIG. 14 illustrates a 3D image formed by the light-field display device of FIG. 13;

FIG. 15 illustrates an example in which the light-field display device according to an exemplary embodiment is applied as a 3D light-field display device for a wrist-type mobile device;

FIG. 16 illustrates an example in which the light-field display device according to an exemplary embodiment is applied as a 3D light-field display device for a smartphone;

FIG. 17 illustrates an example in which the light-field display device according to an exemplary embodiment is applied as a 3D light-field display device for a tablet; and

FIG. 18 illustrates an example in which the light-field display device according to an exemplary embodiment is applied as a large-screen 3D light-field display device, such as a large-screen 3D TV.

### DETAILED DESCRIPTION

Hereinafter, light-field display devices according to various exemplary embodiments will be described more fully with reference to the accompanying drawings. Like reference numerals in the drawings denote like elements, and, in the drawings, the sizes of elements may be exaggerated for clarity and for convenience of explanation. In this regard, the present exemplary embodiments may have different forms and should not be construed as being limited to the descriptions set forth herein. It will be understood that when a layer is referred to as being “on” another layer or substrate, it can be directly on the other layer or substrate, or intervening layers may also be present. While such terms as “first”, “second”, etc., may be used to describe various components, such components must not be limited to the above terms. The above terms are used only to distinguish one component from another.

A singular form may include a plurality of forms unless explicitly represented as such. The terms “comprises” and/or “comprising” or “includes” and/or “including” when used in this specification, specify the presence of stated elements, but do not preclude the presence or addition of one or more other elements. In addition, terms such as “ . . . unit” or the like refer to units that perform at least one function or operation, and the units may be implemented as hardware or software or as a combination of hardware and software.

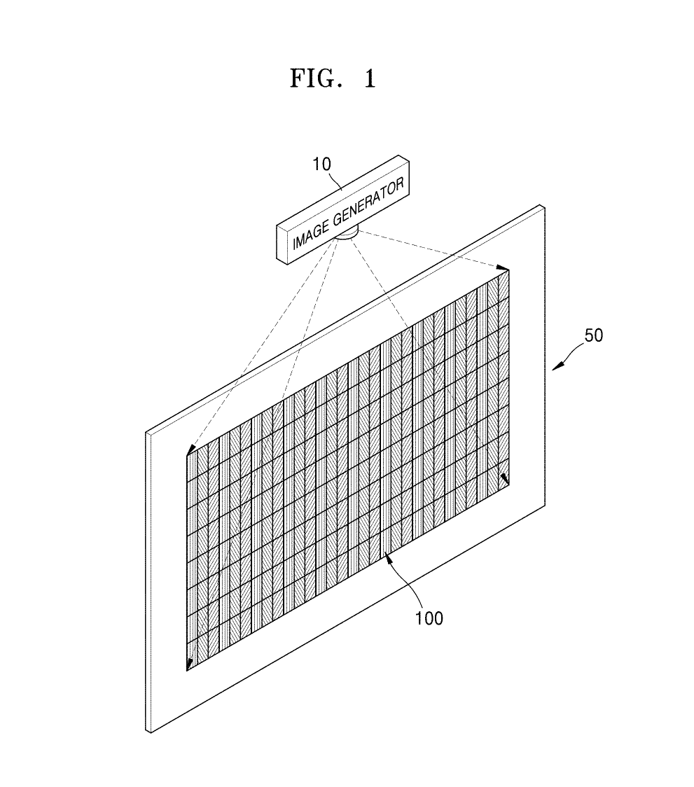

FIG. 1 is a schematic view of a light-field display device according to an exemplary embodiment.

Referring to FIG. 1, the light-field display device according to an exemplary embodiment may be designed to display a 3D image, without using eyeglasses, and may include an image generator 10 and a screen 50 including a grating pixel array 100.

The image generator 10 may radiate light having 3D image information to the screen 50 at a certain angle. When the light-field display device according to an exemplary embodiment displays a 3D image, the image generator 10 may be spaced apart from the screen 50.

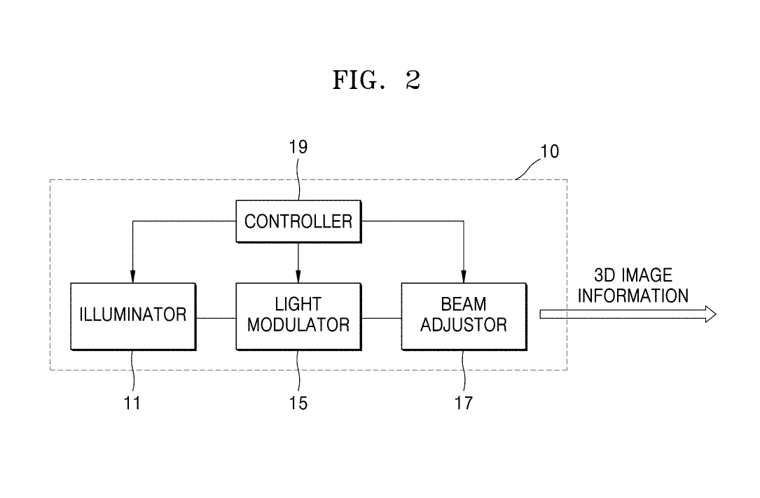

According to an exemplary embodiment, as shown in FIG. 2, the image generator 10 may include a light source 11, a light modulator 15 capable of performing a light control in units of pixels, and a controller 19 that controls the light modulator 15 to generate a pattern having 3D image information. The image generator 10 may further include a beam adjustor 17 that adjusts the magnification of light having generated 3D image information. The beam adjustor 17 may be lens system with an adjustable focal length.

According to an exemplary embodiment, the image generator 10 may include a beam projector that projects a light pattern having 3D image information onto the screen 50. The beam projector used as the image generator 10 may be a related art beam projector. According to an exemplary embodiment, the image generator 10 may be a short distance projector that may be used to easily adjust a distribution of an incidence angle and allow selection of an appropriate angle for diffraction.

For example, because the color and brightness of light emitted by the beam projector may be previously controlled for each pixel via internal modulation, and the specific angle at which the emitted light is incident upon a corresponding grating pixel or sub-grating pixel of the grating pixel array 100 may be defined, grating pixels or sub-grating pixels may be designed accordingly. In other words, the beam projector sends an already generated image to the screen 50 including the grating pixel array 100 arranged thereon, and the grating pixel array 100 performs only a process of turning the image into a light field, thereby realizing a glassesless 3D light-field display device. The image emitted by the beam projector may be an image rendered in connection with the grating pixel array 100. The diffraction angle and the size of each grating pixel or sub-grating pixel of the grating pixel array 100 control the number of views that are to be realized, a viewing angle, and the like. A path of light from the beam projector to the screen 50 and an incidence angle of the light vary according to the area of the screen 50 but are structurally distributed, and thus the grating pixels are arranged at locations that conform to the path of the light and the incidence angle. Herein, a case in which the image generator 10 is a beam projector has been illustrated and described, but exemplary embodiments are not limited thereto. As long as the image generator 10 outputs light including 3D image information to the screen 50 including the grating pixel array 100 arranged thereon, and so long as the grating pixel array 100 only performs a process of turning the light into a light field to thereby realize a glassesless 3D light-field display device, various modifications may be made to the image generator 10.

Because the light-field display device employing the image generator 10 adjusts the image emitted by the image generator 10, the image generator 10 may emit an image according to any of various methods. For example, the image generator 10 may be a beam projector that uses a one-shot method, a single-spot beam scanning method, a line-beam scanning method, or a time sequential emission method, and may generate a to-be-displayed 3D pattern according to any of these methods. To this end, the light modulator 15 of the image generator 10 may be controlled by the controller 19. The one-shot method is a method of forming a single screen at a time using magnifying optical system in a beam projector using a small panel such as a DLP or LCoS. The spot or line-beam scanning method is a method of forming a screen by scanning one spot or line sequentially in a beam projector using a scanner.

The screen 50 may be a multi-directional screen, and thus may include the grating pixel array 100 to diffract incident light in multiple directions. The grating pixel array 100 may be formed on a surface or an internal surface of the screen 50. In the grating pixel array 100, pixels, each having grating formed therein, namely, grating pixels, may be arranged in a 2D array.

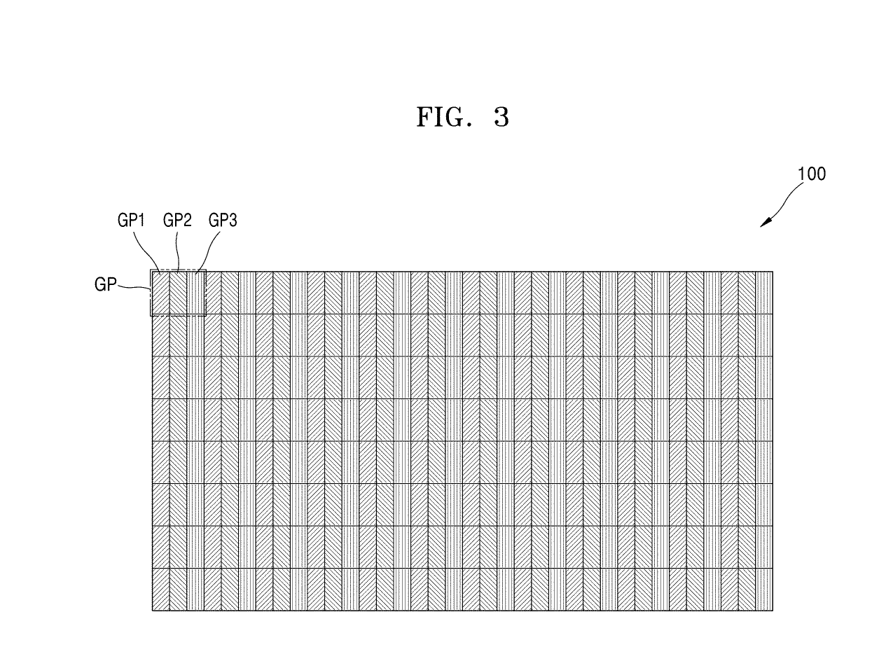

FIG. 3 schematically illustrates an example of the grating pixel array 100 that is applied to the screen 50 of the light-field display device according to an exemplary embodiment.

Referring to FIG. 3, the grating pixel array 100 may include a plurality of grating patterns corresponding to at least one of a direction of the incident light including the 3D information and a wavelength of the incident light including 3D image information. In other words, each grating pixel GP of the grating pixel array 100 may include a grating pattern.

An interaction may occur between the grating pattern and light having a specific wavelength, and the light may be diffracted and emitted in a specific direction according to a combination of the pitch, the arrangement direction, the a refractive index, and the duty cycle of the grating pattern, as well as the relative angle between a traveling direction of the light and the grating pattern.

Each of a plurality of grating patterns may include a plurality of sub grating patterns that depend on the wavelength of light. Each grating pattern may correspond to one pixel of the light modulator 15 of the image generator 10. Each sub-grating pattern may correspond to one sub-pixel of a pixel of the light modulator 15 of the image generator 10. A sub pixel is a unit in which selection of the wavelength of light together with the transmittance of light may be controlled.

For example, each grating pixel GP of the grating pixel array 100 may include a first sub-grating pixel GP1, a second sub-grating pixel GP2, and a third sub-grating pixel GP3. For example, the first sub-grating pixel GP1 may include a first sub grating pattern that reacts to light of a first wavelength, the second sub-grating pixel G2P may include a second sub grating pattern that reacts to light of a second wavelength, and the third sub-grating pixel GP3 may include a third sub grating pattern that reacts to light of a third wavelength. The light of the first through third wavelength may be light having different wavelengths. For example, the first through third wavelengths may correspond to red light, green light, and blue light, respectively.

The grating pixel array 100 may emit light in different directions according to the grating pattern sets. The light emitted in different directions may provide different views, respectively, to thereby display a 3D image. The term “view” used herein may mean an image displayed to one eye of a viewer. However, exemplary embodiments are not limited thereto, and an image corresponding to at least two views may be provided to a single eye of a viewer. The grating pixel array 100 may control an emission direction of light, and, when different views are provided to a viewer according to different emission directions, a 3D image may be displayed. According to the number of grating pattern sets, a plurality of views, for example, 36 views, 48 views, or 96 views, may be provided.

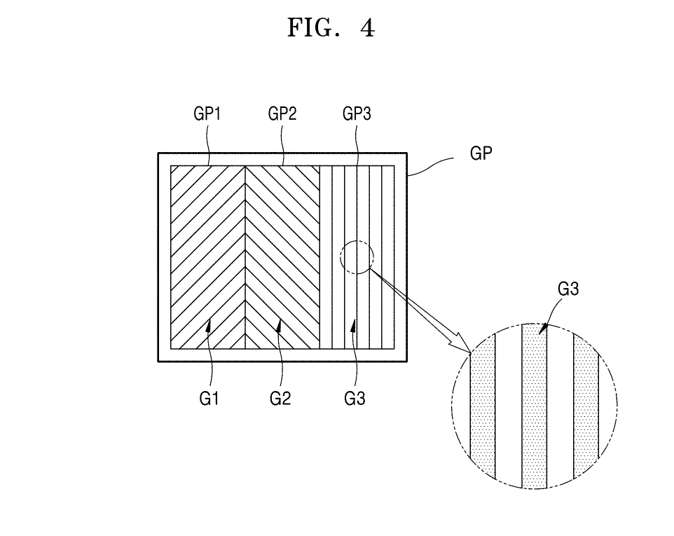

FIG. 4 illustrates a magnification of a grating pixel GP of the grating pixel array 100 of FIG. 3. The grating pixel array 100 may be an arrangement of grating pixels GP as shown in FIG. 4 in a 2D matrix. Each grating pixel GP may include, for example, a first sub-grating pixel GP1, a second sub-grating pixel GP2, and a third sub-grating pixel GP3. The first sub-grating pixel GP1, the second sub-grating pixel GP2, and the third sub-grating pixel GP3 may include different grating patterns G1, G2, and G3, respectively. The first sub-grating pixel GP1, the second sub-grating pixel GP2, and the third sub-grating pixel GP3 may have the same areas.

In the light-field display device according to an exemplary embodiment, light having 3D image information that is provided at an angle by the image generator 10 may be diffracted by the grating pixel array 100 of the screen 50, and thus a 3D image may be formed.

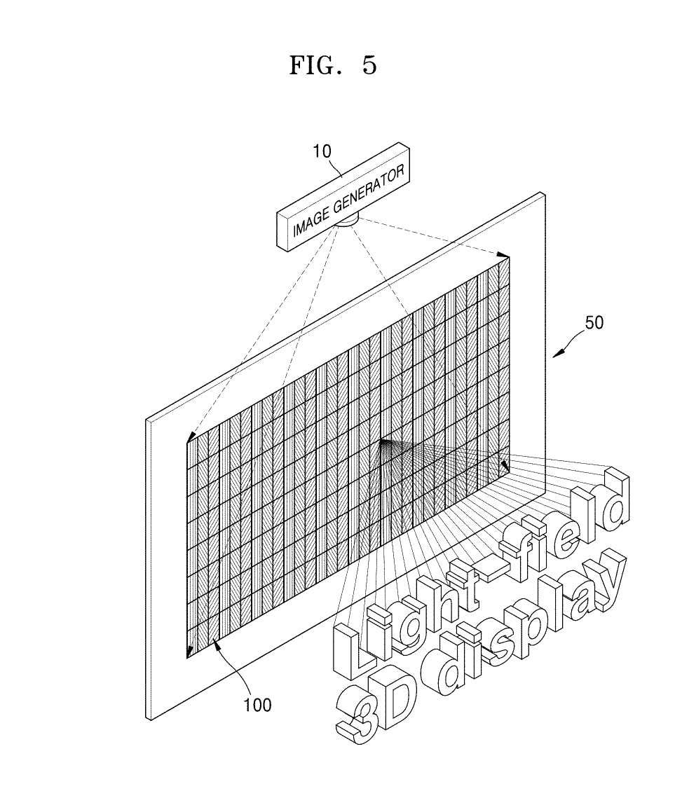

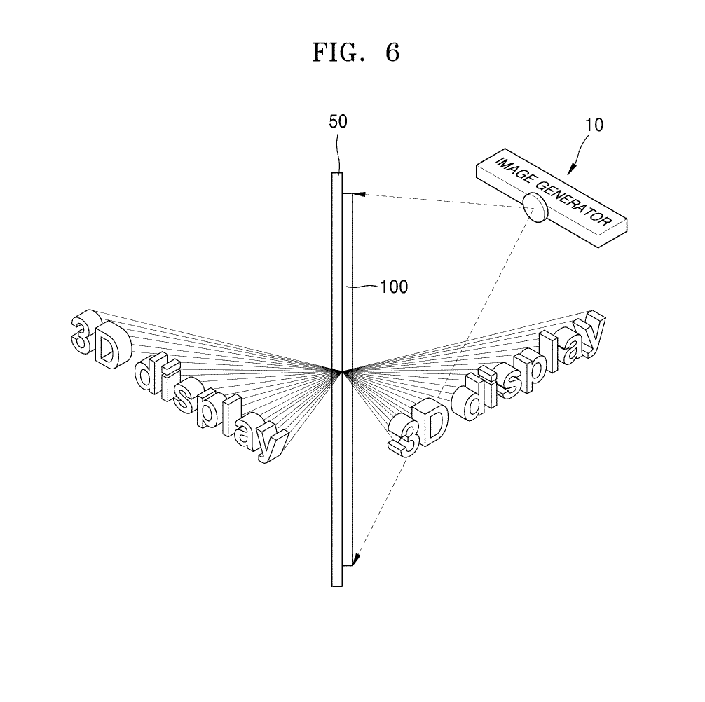

The 3D image formed by the grating pixel array 100 of the screen 50 via diffraction may be formed in front of the screen 50 as shown in FIG. 5, may be formed behind the screen 50, or may be formed in front of the screen and behind the screen 50 as shown in FIG. 6.

Because grating pitches of the grating patterns G1, G2, and G3 formed in each grating pixel GP of the grating pixel array 100 are formed at intervals of, for example, about several hundreds of nm, the grating pixel array 100 is substantially transparent. The screen including the grating pixel array 100 may be used as a see-through display device. The screen 50 including the grating pixel array 100 may also be transparent.

As such, because the screen 50 is transparent, a 3D image may be formed on either one or both of the front side of the screen 50 and the rear side of the screen 50 due to diffraction of the light having the 3D image information by the grating pixel array 100, and thus the light-field display device according to an exemplary embodiment may realize a see-through 3D display device.

Alternately, the screen 50 may be opaque. In this case, the light-field display device according to an exemplary embodiment forms a 3D image via only diffraction in front of the screen 50, using the grating pixel array 100, and thus a reflective 3D display device may be realized.

In view of the above, it is clear that the light-field display device according to an exemplary embodiment may realize a glassesless 3D display device for multiple views while employing a beam projector as the image generator 10. In particular, in contrast with 3D displays employing a related art directional backlight unit, a light-field display device according to an exemplary embodiment employs no light guide plates, and thus the loss generated during light guiding may be reduced. Because the image generator 10 makes light incident on the entire screen 50 all at once, uniformity problems may be prevented. In addition, because both the light source and the modulation portion are structurally included in the image generator 10, namely, a beam projector, the screen 50 may have a simple structure, and thus, as is apparent from the various exemplary embodiments which will be described later, a light-field display device according to an exemplary embodiment is applicable to any of various fields.

Since a light-field display device according to an exemplary embodiment includes the image generator 10 that provides light, having image information, to the screen 50, when the screen 50 is replaced with a conventional screen, not including the grating pixel array 100, and when the image generator 10 is controlled to provide light having only 2D image information, the light-field display device according to an exemplary embodiment may generate a 2D image. As such, since the light-field display device according to an exemplary embodiment has a structure in which the image generator 10 provides light having image information to a screen, 2D/3D conversion is possible via a replacement of the screen.

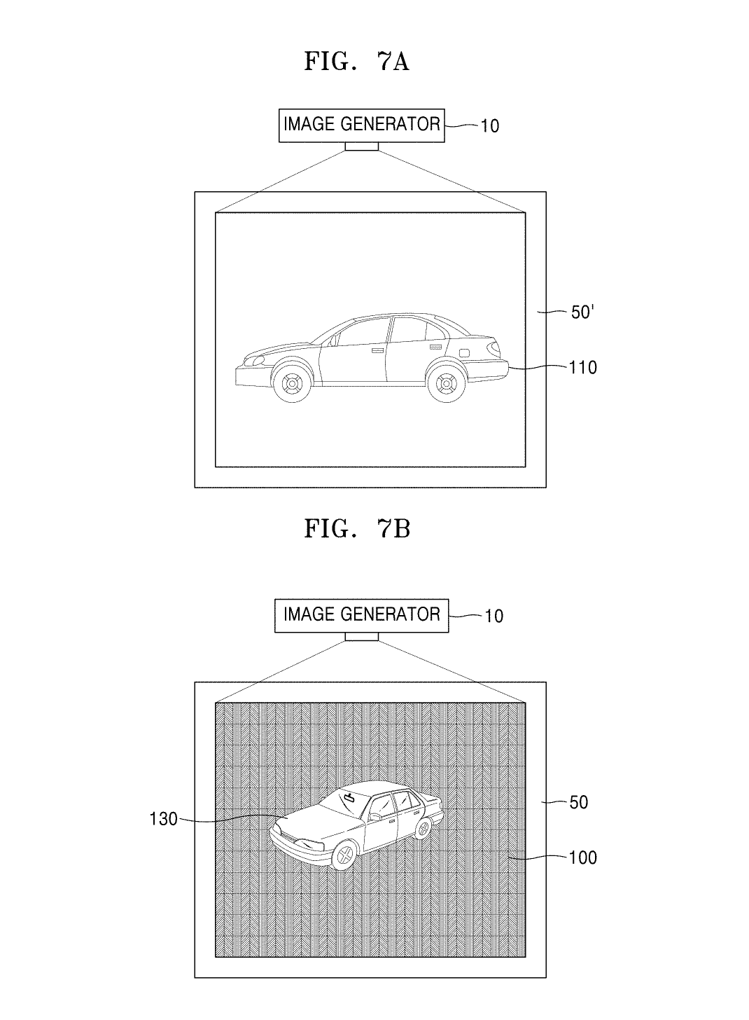

FIG. 7A illustrates a case in which, in a light-field display device according to an exemplary embodiment, the screen 50, including the grating pixel array 100, is replaced with a conventional screen 50′, and the display device forms a 2D image 110. FIG. 7B illustrates a case in which, in a light-field display device according to an exemplary embodiment includes the screen 50, including the grating pixel array 100. and the display device forms a 3D image 130.

As seen from FIGS. 7A and 7B, a light-field display device according to an exemplary embodiment may change from displaying a 2D image 110 to displaying a 3D image 130 by replacement of the screen and a modification of the operation of the image generator 10 in view of the screen replacement.

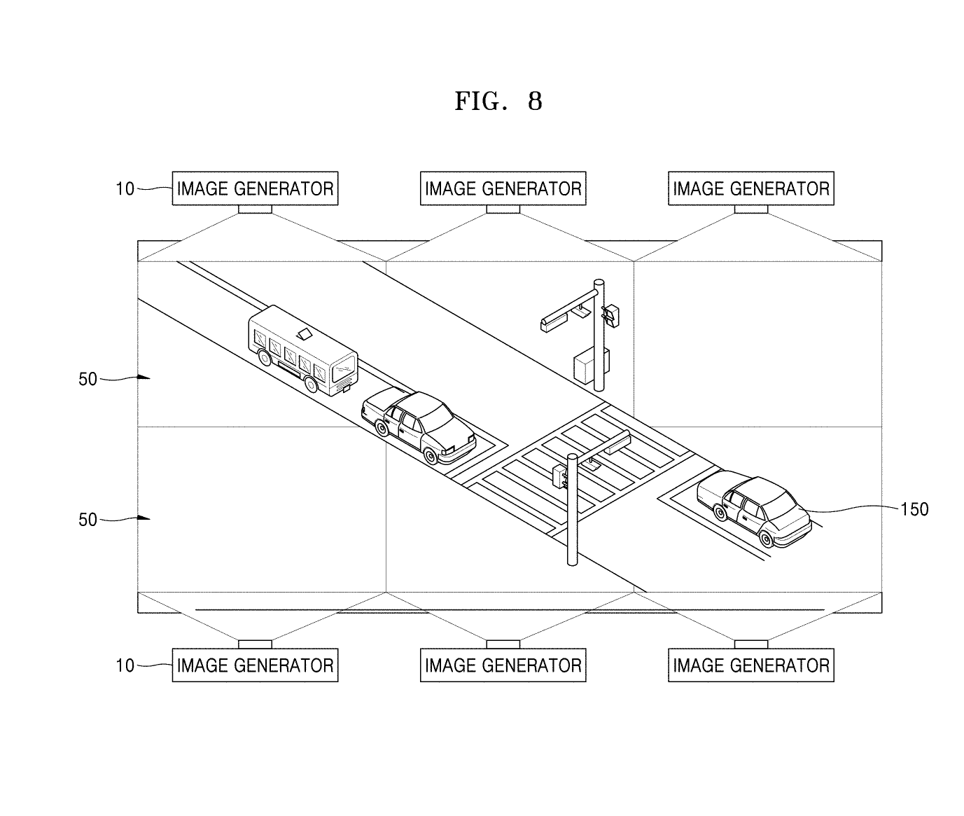

FIG. 8 is a schematic view of a light-field display device according to another exemplary embodiment. FIG. 8 illustrates an example in which a set includes a screen 50 and an image generator 10, and a plurality of such sets are repeated in a 2D array, thereby forming a large screen. Each set forms a 3D image of an area of the large screen corresponding to the set, and, via a combination of 3D images respectively formed by the plurality of sets and the image generator 10, a 3D image 150 may be formed on the large screen, as shown in FIG. 8.

As such, according to another exemplary embodiment, a large area display device may be obtained by selecting an appropriate number of sets, each including an image generator 10 and a screen 50.

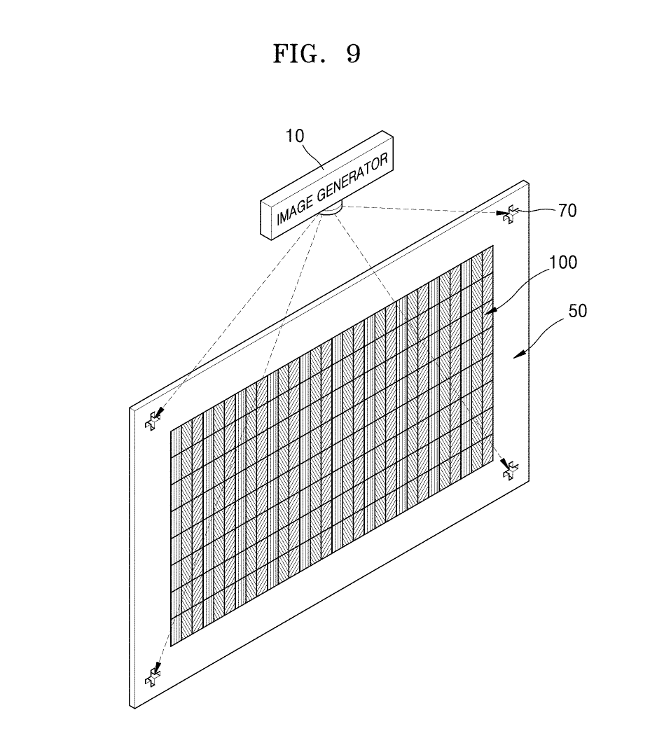

FIG. 9 is a schematic view of a light-field display device according to another exemplary embodiment, and is different from the light-field display device of FIG. 1 in that alignment marks 70 are included at corners of the screen 50.

As such, when alignment marks 70 are included at corners of the screen 50, for example at each of the four corners of the screen 50, the image generator 10 may be configured to adjust the output image according to a sensing of the alignment marks 70 of the screen 50. The light-field display device of FIG. 9 may separately include a detection sensor that senses the alignment marks 70 of the screen 50, or the detection sensor may be included in the image generator 10.

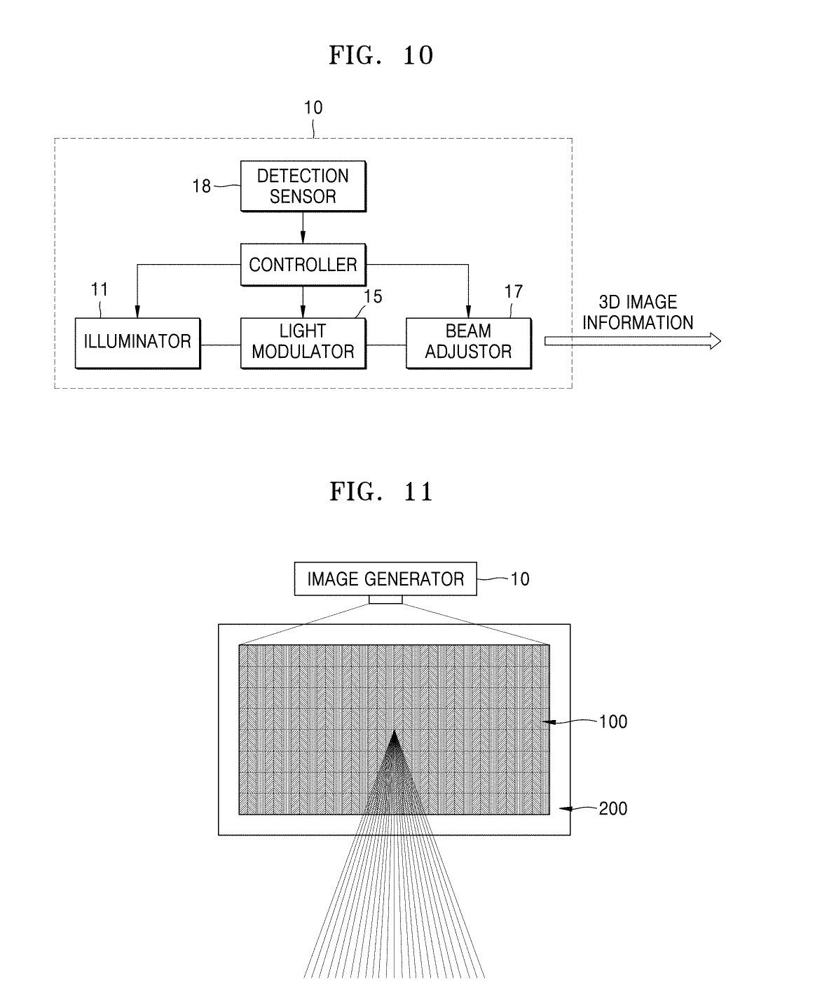

FIG. 10 is a block diagram of the image generator 10 of FIG. 9, and illustrates a case in which the image generator 10 includes a detection sensor that senses the alignment marks 70 of the screen 50.

For example, as shown in FIG. 10, the image generator 10 may include a light source 11; a light modulator 15, capable of performing light control in units of pixels—i.e. individually for each pixel; and a controller 19 that controls the light modulator 15 to generate a pattern having 3D image information. The image generator 10 may further include a beam adjustor 17 that adjusts a magnification of the light. The image generator 10 may further include a detection sensor 18 that senses the alignment marks 70 of the screen 50.

When alignment marks 70 are included at the four corners of the screen 50, the image generator 10 may adjust the output image by sensing the alignment marks 70 of the screen 50, and thus may adjust to movement of the screen 50.

Various examples of applications of a light-field display device according to an exemplary embodiment will now be described.

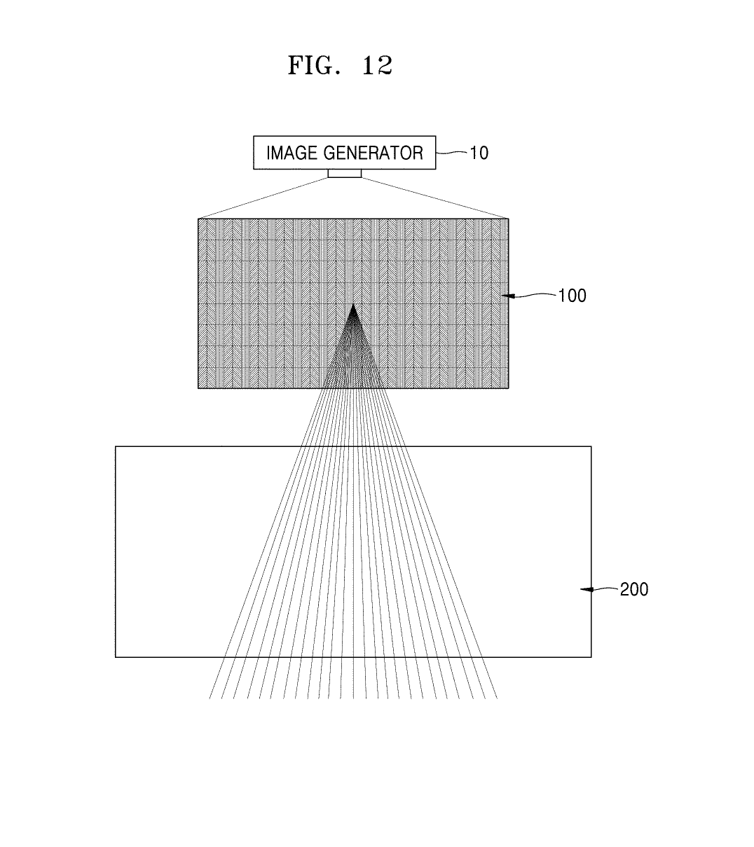

FIGS. 11 and 12 illustrate examples in which a light-field display device according to an exemplary embodiment is applied to a 3D light-field display device of an automobile.

Referring to FIG. 11, the screen 50 may be a windshield 200 of an automobile. In other words, the grating pixel array 100 may be provided on the windshield 200, and the image generator 10 may be provided on the automobile to cause light, comprising 3D image information, to be incident on the grating pixel array 100 at a certain angle. In this case, for example, a road guide image, an image of a recognition camera, and or the like may be displayed as 3D images on the windshield 200 by using the light-field display device according to an exemplary embodiment.

Referring to FIG. 12, the light-field display device according to an exemplary embodiment may be disposed such that a 3D image, diffracted by the grating pixel array 100 of the screen 50, is formed on the windshield 200 of an automobile. In this case, the image generator 10 and the screen 50 including the grating pixel array 100 may be disposed above and in front of a driver's seat. A road guide image, an image of a recognition camera, or the like may be displayed as 3D images on the windshield 200 by using a light-field display device as shown in FIG. 12.

Alternatively, rather than a light-field display device, as shown in FIGS. 11 and 12, displaying a 3D image in front of a driver's seat, a light-field display device may be configured to display a 3D image to a passenger in another sear of the automobile. Accordingly, not only a road guide image, an image of a recognition camera, or the like but also any of various sorts of images desired by a passenger may be displayed three-dimensionally.

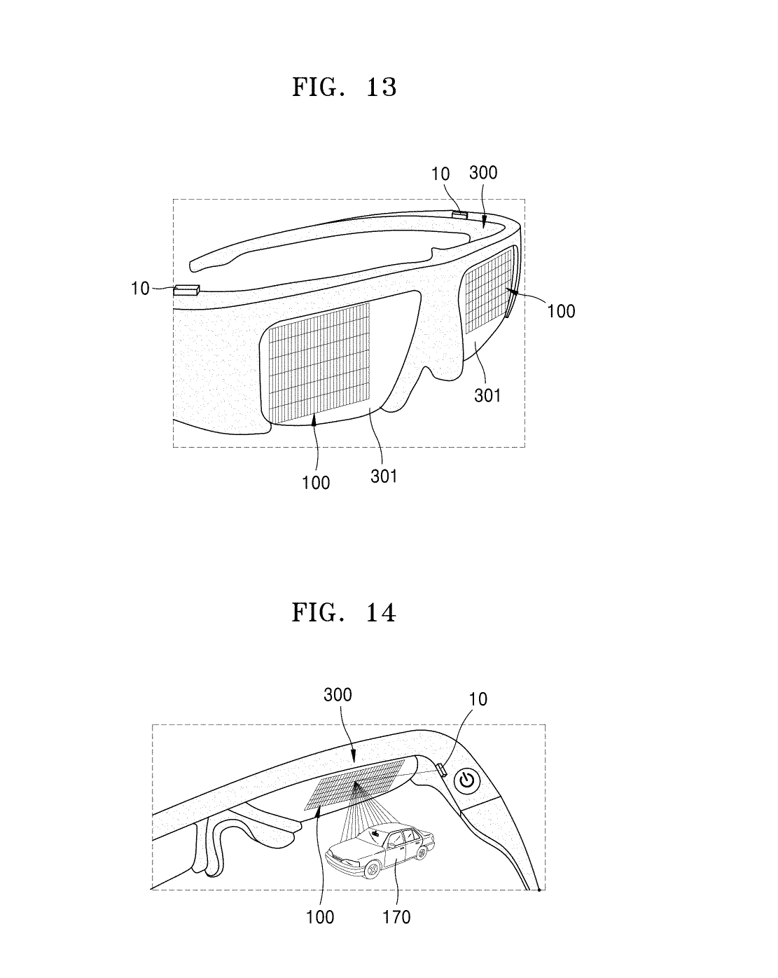

FIG. 13 illustrates an example in which a light-field display device according to an exemplary embodiment is a 3D light-field display device for 3D eyeglasses. FIG. 14 illustrates a 3D image 170 formed by the light-field display device of FIG. 13.

Referring to FIGS. 13 and 14, the light-field display device may be an eyeglasses-type 3D light-field display device. In this case, the screen 50 may correspond to a lens 301 of the glasses. In other words, the grating pixel array 100 may be formed on the lens 301. The image generator 10 may be provided on a frame 30 of the eyeglasses, so that it may output the light, including the 3D image information, to the grating pixel array 100 at a certain angle.

A user who wears the eyeglasses having such a 3D light-field display device integrated therewith may view a 3D image using the eyeglasses.

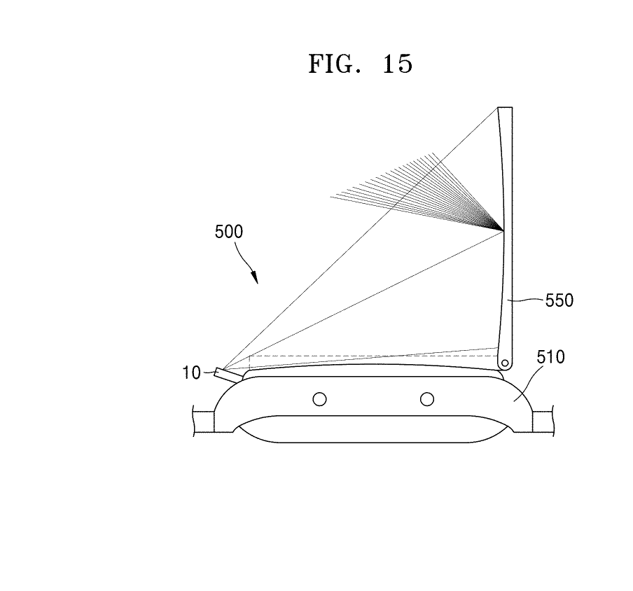

FIG. 15 illustrates an example in which a light-field display device according to an exemplary embodiment is a 3D light-field display device for a wrist-type mobile device.

Referring to FIG. 15, the screen 50 may be a cover 550 of a wrist-type mobile device 500 that is openable, and the image generator 10 may be disposed on a body 510 of the wrist-type mobile device 500. In other words, the grating pixel array 100 may be provided on the cover 550. In this case, the image generator 10 may be disposed such that, when the cover 550, namely, the screen 50, is open, light including 3D image information generated by the image generator 10 may be output such that it is incident at a certain angle on the grating pixel array 100 provided on the cover 550. In this case, the light including the 3D image information may be diffracted by the grating pixel array 100 to form a 3D image.

Although the image generator 10 protrudes from the body 510 of the wrist-type mobile device 500, as shown in FIG. 15, when the cover 550, namely, the screen 50, is folded, and thus closely contacts the body 510 of the wrist-type mobile device 500 as indicated by a dashed line, the image generator 10 may be in a position in which it does not protrude from the body 510 of the wrist-type mobile device 500. Alternately, the image generator 10 may be slidingly insertable into the body 510.

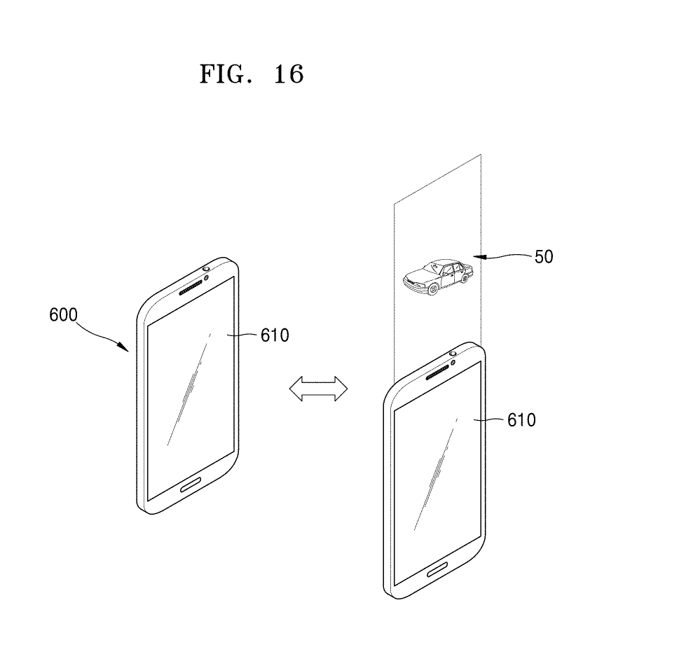

FIG. 16 illustrates an example in which a light-field display device according to an exemplary embodiment is used as a 3D light-field display device of a smartphone. The left portion of FIG. 16 illustrates operations of a smartphone 600 and a light-field display device included in the smartphone 600 when a 2D image is formed, and the right portion of FIG. 16 illustrates operations of the smartphone 600 and the light-field display device included in the smartphone 600 when a 3D image is formed. In FIG. 16, illustration of the image generator 10 is omitted.

Referring to FIG. 16, the screen 50 may be configured to be slidably pulled out from the body of the smartphone 600. The image generator 10 may, likewise, be removable from within the body of the smartphone 600. When a 2D image is formed, a display device 610 of the smartphone 600 may be used. When a 3D image is to be formed, the screen 50 may be pulled out from the body of the smartphone 600, and light having 3D image information, which is output by the image generator 10 to be incident, at a specific angle, onto the grating pixel array 100, is diffracted by the grating pixel array 100, thereby forming a 3D image. In this case, the screen 50 may be a touch screen, and the 3D image information generated by the image generator 10 may be determined according to information obtained via a touch of the screen 50, and thus an operation, such as, magnification or shrinkage of the 3D image, may be performed.

The screen 50 may be slidingly coupled to the body of the smartphone 600. The image generator 10 may also be slidingly coupled to the body of the smartphone 600.

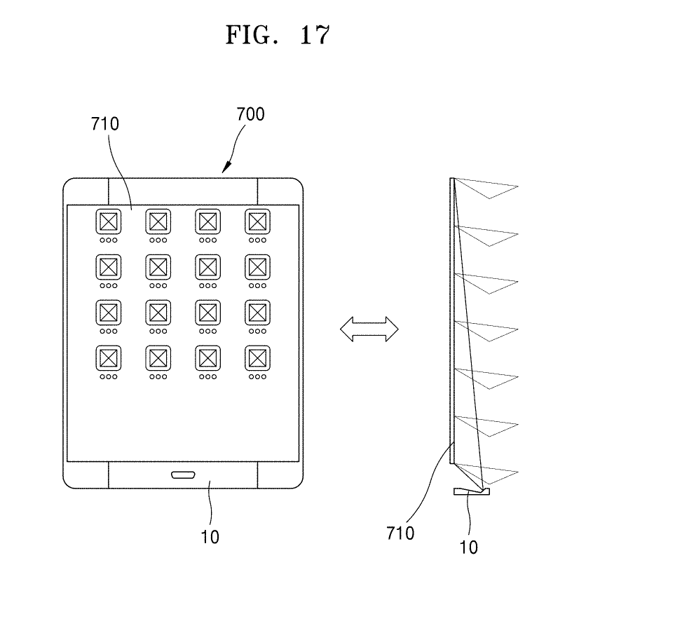

FIG. 17 illustrates an example in which a light-field display device according to an exemplary embodiment is a 3D light-field display device of a tablet. The left portion of FIG. 17 is a plan view of the 3D light-field display device for tablets, and the right portion of FIG. 17 is a side view of the 3D light-field display device for tablets.

Referring to FIG. 17, the screen 50 of the light-field display device according to an exemplary embodiment may correspond to a display device 710 of a tablet 700, and the image generator 10 may be disposed on one side of the tablet 700 to radiate light, including 3D image information, onto the display device 710 of the tablet 700 at a certain angle. The display device 710 of the tablet 700 may include the grating pixel array 100, to diffract the light including the 3D image information, thereby forming a 3D image. For example, the tablet 700 may be a transparent liquid crystal display device (LCD) or a transparent organic LED (OLED), or may be a reflective LCD or a reflective OLED. Although the image generator 10 is disposed on a lower end portion of the tablet 700 as shown in FIG. 17, the location of the image generator 10 may vary, as would be understood by one of skill in the art.

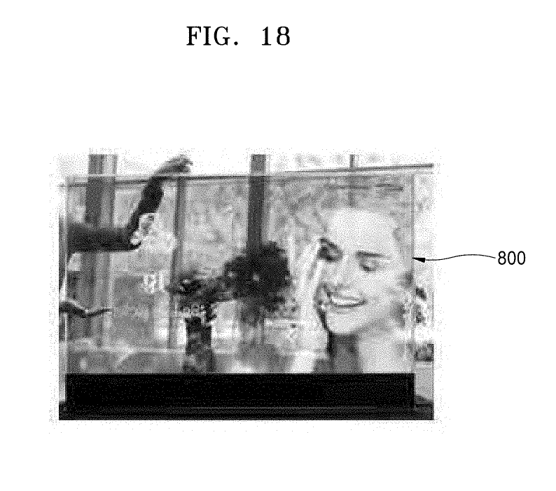

FIG. 18 illustrates an example in which a light-field display device according to an exemplary embodiment is a large-screen 3D light-field display device, such as a large-screen 3D TV.

Referring to FIG. 18, the screen 50 of the light-field display device according to an exemplary embodiment may be a screen 800 of a TV, and the grating pixel array 100 may be provided on the screen 800 to diffract incident light and form a 3D image. The image generator 10 may radiate light, having 3D image information, onto the screen 800 at a certain angle. For example, the image generator 10 may be disposed on a lower portion of the screen 800, or the location of the image generator 10 may be determined as would be understood by one of skill in the art. In FIG. 18, illustration of the image generator 10 is omitted.

The screen 800 may be a transparent display device and a 3D image may be formed by the screen 800. A transparent LCD or a transparent OLED may be used as the transparent display device. As another example, a reflective display device, for example, a reflective LCD or a reflective OLED, may be used instead of the transparent display device. FIG. 18 illustrates a case in which the screen 800 is a transparent display device.

A light-field display device according to an exemplary embodiment includes an image generator that radiates light having 3D image information onto a screen at an angle, and a grating pixel array that diffracts, in multiple directions, light incident on the screen, and forms a 3D image by the diffraction of the incident light from image generator.

Therefore, a 3D image may be realized according to a glassesless light-field method.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A light-field display device comprising:
a screen, and
an image generator configured to radiate light comprising three-dimensional (3D) image information onto the screen at a predetermined angle;
wherein the screen comprises a grating pixel array configured to diffract, in multiple directions, the light comprising the 3D image information, thereby forming a 3D image.

2. The light-field display device of claim 1, wherein the grating pixel array is disposed on a surface of the screen or within the screen.

3. The light-field display device of claim 1, wherein the image generator is spaced apart from the screen.

4. The light-field display device of claim 1, wherein the image generator comprises a beam projector.

5. The light-field display device of claim 1, wherein the image generator comprises:
a light source configured to output light;
a light modulator configured modulate the light, output by the light source, on a pixel-by-pixel basis; and
a controller configured to control the light modulator to output the light comprising the 3D image information.

6. The light-field display device of claim 5, wherein the image generator further comprises a beam adjustor configured to adjust a magnification of the light comprising the 3D image information.

7. The light-field display device of claim 5, wherein
the screen comprises an alignment mark, and
the image generator further comprises a detection sensor configured to sense the alignment mark of the screen.

8. The light-field display device of claim 1, wherein the image generator is configured to generate, via one of a one-shot method, a single-spot beam scanning method, a line-beam scanning method, and a time sequential emission method, the 3D image.

9. The light-field display device of claim 1, wherein the screen is transparent.

10. The light-field display device of claim 1, wherein
the screen comprises an alignment mark, and
the image generator is configured to sense the alignment mark of the screen and to adjust the 3D image information based on the sensing of the alignment mark.

11. The light-field display device of claim 1, wherein the screen comprises an eyeglass lens.

12. The light-field display device of claim 1, wherein the screen comprises a windshield of an automobile.

13. The light-field display device of claim 1, wherein the screen is disposed on an automobile, such that the 3D image is formed on a windshield of the automobile.

14. The light-field display device of claim 1, wherein the screen comprises a cover of a wrist-type mobile device that is opened.

15. The light-field display device of claim 1, wherein the screen is slidably moveable with respect to a smartphone.

16. The light-field display device of claim 1, wherein
the grating pixel array comprises a 2D array of grating pixels, and
each grating pixel comprises a grating pattern configured to diffract light having a specific wavelength.

17. The light-field display device of claim 16, wherein
each grating pixel comprises at least a first sub grating pixel configured to diffract light of a first wavelength and a second sub grating pixel configured to diffract light of a second wavelength, different from the first wavelength.

18. The light-field display device of claim 16, wherein the grating pixel array is transparent.

19. A light-field display device comprising:
an image generator comprising a light source and a modulator configured to modulate light from the light source and output light comprising three-dimensional (3D) image information;
a screen; and
a grating pixel array comprising a two-dimensional array of grating pixels, each of which diffract, in multiple directions, the light comprising the 3D image information, thereby displaying a 3D image.
